(19) United States
(12) Patent Application Publication
(10) Pub. No.: US 2015/0070932 A1
(43) Pub. Date: Mar. 12, 2015

(54) LIGHT SOURCE UNIT USING QUANTUM DOT PACKAGE AND DISPLAY HAVING THE SAME

(71) Applicant: SAMSUNG ELECTRONICS CO., LTD., Suwon-si (KR)

(72) Inventors: Dong Earn KIM, Seoul (KR); Jeong Hee LEE, Seongnam-si (KR); Eun Joo JANG, Suwon-si (KR); Min Jong BAE, Yongin-si (KR); Sang Eui LEE, Hwaseong-si (KR)

(21) Appl. No.: 14/445,678

(22) Filed: Jul. 29, 2014

(30) Foreign Application Priority Data
Sep. 9, 2013 (KR) 10-2013-0107993

(51) Int. Cl. F21V 8/00

(52) U.S. Cl. CPC G02B 6/0028; G02B 6/0025; Y10S 977/774; B82Y 20/00
USPC 362/610; 362/608; 977/774; 977/950

(57) ABSTRACT

A light source unit includes: a light guiding plate having a front surface and a rear surface facing each other, and a side surface between the front surface and the rear surface; a light guiding bar disposed on the side surface of the light guiding plate; a quantum dot package disposed on a surface of the light guiding bar; and a dot light source which provides light to the quantum dot package.

### CROSS-REFERENCE TO RELATED APPLICATION

This application claims priority to Korean Patent Application No. 10-2013-0107993, filed on Sep. 9, 2013, and all the benefits accruing therefrom under 35 U.S.C. §119, the content of which in its entirety is herein incorporated by reference.

### BACKGROUND

(1) Field

This disclosure relates to a light source unit which emits white light using a quantum dot package.

(2) Description of the Related Art

A method of converting a dot light source such as a light emitting diode (“LED”) into a surface light source and using the light from the surface light source as a light or a backlight of a liquid crystal display device is known. To convert the dot light source into the surface light source, firstly, the dot light source is arranged in a line to realize a linear light source, and a light guiding plate to disperse the linear light is generally used. Also, to realize white light, a plurality of dot light sources that emits light of red, green and blue are collectively used, or a phosphor is applied to the dot light source that emits blue or ultraviolet rays to realize the white light.

### SUMMARY

Dispersion of the light generated using such a method described above may not be substantially uniform, and the white light generated using such a method may not be divided into three primary colors such that color reproducibility may be deteriorated when the method is applied to a display device.

Exemplary embodiments are directed to a surface light source with improved light uniformity.

Other exemplary embodiments are directed to a light source that improves color reproducibility of a display device.

An exemplary embodiment of a light source unit includes: a light guiding plate having a front surface and a rear surface facing each other, and a side surface between the front surface and the rear surface; a light guiding bar disposed on the side surface of the light guiding plate; a quantum dot package disposed on a surface of the light guiding bar; and a dot light source which provides light to the quantum dot package.

In an exemplary embodiment, the light guiding bar may have a wedge shape, and the quantum dot package and the dot light source may be disposed on a surface corresponding to a wedge head of the light guiding bar.

In an exemplary embodiment, the light guiding bar may include first and second light guiding bars disposed in symmetry to each other with respect to the light guiding plate, the quantum dot package may include first and second quantum dot packages disposed on surfaces corresponding to wedge heads of the first and second light guiding bars, respectively, and the dot light source may include first and second dot light sources disposed on the surfaces corresponding to the wedge heads in the first and second light guiding bars, respectively.

In an exemplary embodiment, each of the front surface and the rear surface of the light guiding plate may be in a rectangular shape, the side surface of the light guiding plate may include a pair of long side surfaces facing each other and a pair of short side surfaces facing each other, the light guiding bar may include a first light guiding bar disposed on one of the short side surfaces of the light guiding plate and a second light guiding bar disposed on one of the long side surfaces of the light guiding plate, the quantum dot package may include a first quantum dot package disposed on a surface corresponding to a wedge head of the first light guiding bar and a second quantum dot package disposed on a surface corresponding to a wedge head of the second light guiding bar, and the dot light source may include a first dot light source disposed on the first quantum dot package and a second dot light source disposed on the second quantum dot package.

In an exemplary embodiment, the light guiding bar may have a both-sided wedge shape, and the quantum dot package and the dot light source may be disposed on a center of the light guiding bar.

In an exemplary embodiment, the light guiding bar may include first and second light guiding bars disposed in symmetry to each other with respect to the light guiding plate, the quantum dot package may include first and second quantum dot packages disposed on centers of the first and second light guiding bars, respectively, and the dot light source may include first and second dot light sources disposed on the first and second quantum dot packages, respectively.

In an exemplary embodiment, each of the front surface and the rear surface of the light guiding plate may be in a rectangular shape, the side surface of the light guiding plate may include a pair of long side surfaces facing each other and a pair of short side surfaces facing each other, the light guiding bar may include a first light guiding bar disposed on one of the short side surfaces of the light guiding plate and a second light guiding bar disposed on one of the long side surfaces of the light guiding plate, the quantum dot package may include a first quantum dot package disposed on a center of the first light guiding bar and a second quantum dot package disposed on a center of the second light guiding bar, and the dot light source may include a first dot light source disposed on the first quantum dot package and a second dot light source disposed on the second quantum dot package.

In an exemplary embodiment, each of the front surface and the rear surface of the light guiding plate may be in a rectangular shape, and the side surface of the light guiding plate may include a pair of long side surfaces facing each other and a pair of short side surfaces facing each other. In such an embodiment, the light guiding bar may be disposed on one of four side surfaces of the light guiding plate, and the quantum dot package may include a first quantum dot package disposed on the one of the four side surfaces of the light guiding plate, and second and third quantum dot packages respectively disposed on two corners opposite to the one of the four side surfaces, and the dot light source may include a first dot light source disposed on the one of the four side surfaces of the light guiding plate, and second and third dot light sources respectively disposed on the two corners opposite to the one of the four side surfaces.

An exemplary embodiment of a light source unit according to the invention includes: a light guiding plate having a front surface and a rear surface facing each other, and a side surface between the front surface and the rear surface; a light guiding bar disposed on the side surface of the light guiding plate; a bar shaped quantum dot package disposed between the light guiding bar and the side surface of the light guiding plate; and a dot light source which provides light to the light guiding bar.

In an exemplary embodiment, the light guiding bar may have a wedge shape, and the dot light source may be disposed on a surface corresponding to a wedge head of the light guiding bar.

In an exemplary embodiment, the bar shaped quantum dot package may include first and second bar shaped quantum dot packages disposed in symmetry to each other with respect to the light guiding plate, the light guiding bar may include first and second light guiding bars disposed on the first and second bar shaped quantum dot packages, respectively, and the dot light source may include first and second dot light sources disposed on surfaces corresponding to wedge heads of the first and second light guiding bars, respectively.

In an exemplary embodiment, each of the front surface and the rear surface of the light guiding plate may be in a rectangular shape, the side surface of the light guiding plate may include a pair of long side surfaces facing each other and a pair of short side surfaces facing each other, the light guiding bar may include a first light guiding bar disposed on one of the short side surfaces of the light guiding plate and a second light guiding bar disposed on one of the long side surfaces of the light guiding plate, the bar shaped quantum dot package may include a first bar shaped quantum dot package disposed between the light guiding plate and the first light guiding bar and a second bar shaped quantum dot package disposed between the light guiding plate and the second light guiding bar, and the dot light source may include a first dot light source disposed on a surface corresponding to a wedge head of the first light guiding bar and a second dot light source disposed on a surface corresponding to a wedge head of the second light guiding bar.

In an exemplary embodiment, the light guiding bar may have a both-sided wedge shape, and the dot light source may be disposed on a center of the light guiding bar.

In an exemplary embodiment, the bar shaped quantum dot package may include first and second bar shaped quantum dot packages disposed in symmetry to each other with respect to the light guiding plate, the light guiding bar may include first and second light guiding bars disposed on the first and second bar shaped quantum dot packages, respectively, and the dot light source may include first and second dot light sources disposed on centers of the first and second light guiding bars, respectively.

In an exemplary embodiment, each of the front surface and the rear surface of the light guiding plate may be in a rectangular shape, the side surface of the light guiding plate may include a pair of long side surfaces facing each other and a pair of short side surfaces facing each other, the light guiding bar may include a first light guiding bar disposed on one of the short side surfaces of the light guiding plate and a second light guiding bar disposed on one of the long side surfaces of the light guiding plate, the bar shaped quantum dot package may include a first bar shaped quantum dot package disposed between the light guiding plate and the first light guiding bar and a second bar shaped quantum dot package disposed between the light guiding plate and the second light guiding bar, and the dot light source may include a first dot light source disposed on a center of the first light guiding bar and a second dot light source disposed on a center of the second light guiding bar.

An exemplary embodiment of a light source unit according to the invention may include: a light guiding plate having a front surface and a rear surface facing each other, and a side surface between the front surface and the rear surface; a quantum dot package disposed on the side surface of the light guiding plate and which directly provides light to the light guiding plate; and a dot light source which provides light to a quantum dot package.

In an exemplary embodiment, each of the front surface and the rear surface of the light guiding plate may be in a rectangular shape, the side surface of the light guiding plate may include a pair of long side surfaces facing each other and a pair of short side surfaces facing each other, and the quantum dot package and the dot light source may be disposed on at least one of four corners of the light guiding plate.

In an exemplary embodiment, the quantum dot package and the dot light source may be disposed on each of all of the four corners of the light guiding plate.

In an exemplary embodiment, each of the front surface and the rear surface of the light guiding plate be in a rectangular shape, the side surface of the light guiding plate has a pair of long side surfaces facing each other and a pair of short side surfaces facing each other, and the quantum dot package and the dot light source may be disposed on at least one among four side surfaces of the light guiding plate.

In an exemplary embodiment, the quantum dot package and the dot light source may be disposed on a center of each of the four side surface of the light guiding plate.

In an exemplary embodiment, the quantum dot package may include a first quantum dot package disposed on the at least one of the four side surfaces of the light guiding plate, and a second quantum dot package disposed on at least one of four corners of the light guiding plate, and the dot light source may include a first dot light source disposed on the at least one of the four side surfaces of the light guiding plate, and a second dot light source disposed on the at least one of the four corners of the light guiding plate.

According to exemplary embodiments of the invention, the dot light source and the dot quantum dot package are directly applied to the light guiding plate or are used along with the light guiding bar, or the dot light source and the linear quantum dot package are applied along with the light guiding bar to realized the surface light source, and thereby the light uniformity of the light source is substantially improved, and color reproducibility of a display device including such a light source is substantially improved when being applied to.

### BRIEF DESCRIPTION OF THE DRAWINGS

The above and other features of the invention will become more apparent by describing in further detail exemplary embodiments thereof with reference to the accompanying drawings, in which:

FIG. 1 is a cross-sectional view of an exemplary embodiment of a liquid crystal display device; and

FIG. 2 to FIG. 19 are perspective views of exemplary embodiments of a light source.

### DETAILED DESCRIPTION OF THE EMBODIMENTS

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of a liquid crystal display device according to the invention will be described in detail with reference to the accompanying drawings.

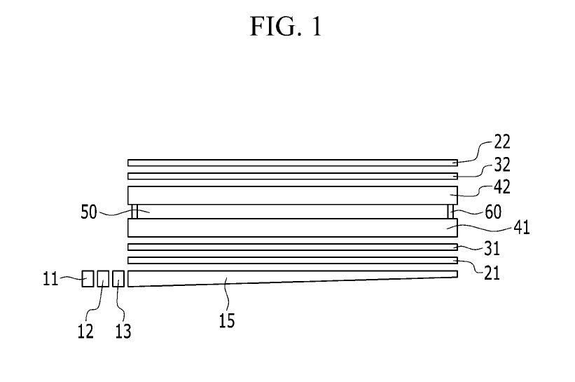

Firstly, referring to FIG. 1, an exemplary embodiment of a liquid crystal display device including a light source will be described in detail.

FIG. 1 is a cross-sectional view of an exemplary embodiment of a liquid crystal display device.

An exemplary embodiment of the liquid crystal display device according to the invention includes a liquid crystal panel including a lower substrate 41, a upper substrate 42 and a liquid crystal layer 50 interposed therebetween and sealed by a sealing material 60, optical films 31 and 32 and polarizing light films 21 and 22 respectively disposed on and under the liquid crystal panel, and a light source unit including a light guiding plate 15, a light guiding bar 13, a quantum dot package 12 and a light source 11.

The lower and upper substrates 41 and 42 of the liquid crystal panel may include a transparent insulating material such as glass, for example, or may be flexible substrates including a plastic, for example. The liquid crystal layer 50 may include or be formed of one of various liquid crystals such as a twisted nematic (“TN”) liquid crystal or a vertically aligned (“VA”) liquid crystal.

In an exemplary embodiment, as shown in FIG. 1, the optical films 31 and 32 are respectively disposed on and under the liquid crystal panel, but not being limited thereto. In an alternative exemplary embodiment, the optical films 31 and 32 may be disposed only at one side of the liquid crystal panel or may be disposed one on another on or under the liquid crystal panel. The optical films 31 and 32 may include a retardation film that retards a phase of light passing therethrough to change a polarizing light state of the light, and a diffusion film that uniformly disperses light passing therethrough.

The light source 11 of the light source unit may be a dot type light source including a single blue light emitting diode (“LED”) or a single ultraviolet ray LED, or a bar shaped light source in which a plurality of blue LEDs or a plurality of ultraviolet ray LEDs are arranged. The quantum dot package 12 has a structure including a light conversion material dispersed with a quantum dot material, in which semiconductor or metal nanoparticles are disposed in a dispersion medium, such as a resin, in a protecting member. In such an embodiment, the protecting member may include or be made of glass, for example. The quantum dot converts the blue light or the ultraviolet ray light emitted from the light source 11 into white light by converting the blue light or the ultraviolet ray light into green light, red light or blue light according to a size thereof. The quantum dot may include a center nanocrystal and a shell nanocrystal enclosing the center nanocrystal, and may further include an organic ligand coupled to the shell nanocrystal or an organic coating layer enclosing the shell nanocrystal. The quantum dot material may include a Si-based nanocrystal, a group II-VI-based compound semiconductor nanocrystal, a group III-V-based compound semiconductor nanocrystal, a group IV-VI-based compound semiconductor nanocrystal, or a combination thereof. The group II-VI-based compound semiconductor nanocrystal may include CdS, CdSe, CdTe, ZnS, ZnSe, ZnTe, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HggZnTe, CdZnSeS, CdZnSeTe, CdZnSTe, CdHgSeS, CdHgSeTe, CdHgSTe, HgZnSeS, HgZnSeTe, HgZnSTe or a combination thereof, the group III-V-based compound semiconductor nanocrystal may include GaN, GaP, GaAs, AlN, AlP, AlAs, InN, InP, InAs, GaNP, GaNAs, GaPAs, AlNP, AlNAs, AlPAs, InNP, InNAs, InPAs, GaAlNP, GaAlNAs, GaAlPAs, GaInNP, GaInNAs, GaInPAs, InAlNP, InAlNAs, InAlPAs or a combination thereof, and the group IV-VI-based compound semiconductor nanocrystal may include SbTe, for example. In such an embodiment, the resin may include silicon, an epoxy, an acrylate or a combination thereof. In such an embodiment, a conversion wavelength may be controlled by controlling a size of a central body of the quantum dot. The light guiding bar 13 converts the light emitted from the quantum dot package 12 into linear light and provides the linear light to the light guiding plate 15. The light guiding plate 15 disperses the linear light provided from the light guiding bar 13 to be converted into surface light. A thickness of the light guiding plate 15 may be decreased as being farther away from the light guiding bar 13, and a width of the light guiding bar 13 may be decreased as being farther away from the quantum dot package 12, thereby forming a wedge shape.

In an exemplary embodiment, the quantum dot package 12 of the light source unit converts the blue light emitted from the dot light source 11 into the white dot light and provides the white dot light to the light guiding bar 13, and the light guiding bar 13 disperses the white dot light into white linear light and provides the white linear light to the light guiding plate 15. The light guiding plate 15 disperses the white linear light into white surface light to be emitted toward the liquid crystal panel. In an exemplary embodiment, where the quantum dot package 12 is used to convert the blue light into the white light, the white light may be generated to have distinct peaks of green light and red light as well as the blue light. Accordingly, in such an embodiment, color purity selected by a color filter of the liquid crystal panel may become high, and a reproducible color range of the liquid crystal display device may become wide. In such an embodiment, the blue light emitted from the dot light source 11 may be directly converted into the white dot light by the quantum dot package 12, and then converted into the surface light through the light guiding bar 13 and the light guiding plate 15, thereby increasing uniformity of the white surface light.

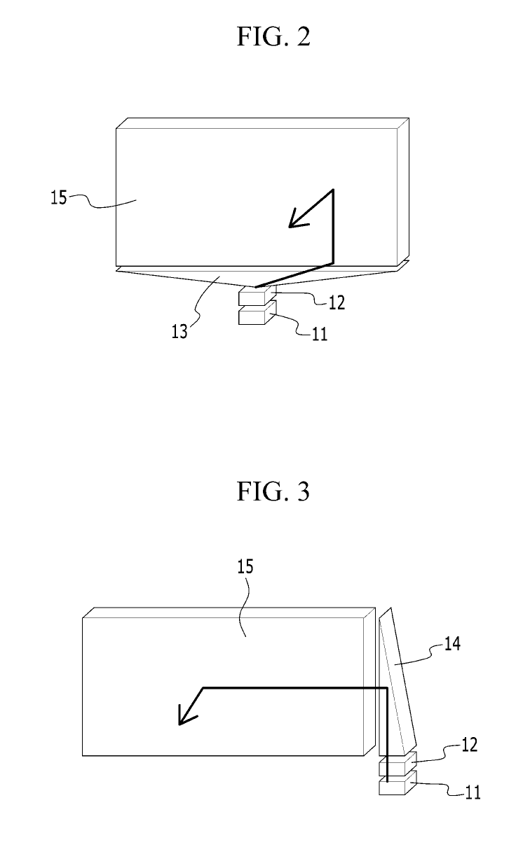

Various exemplary embodiments of the light source unit will be described with reference to FIG. 2 to FIG. 19. FIG. 2 to FIG. 19 are perspective views of exemplary embodiments of a light source.

In an exemplary embodiment of a light source unit, as shown in FIG. 2, the light guiding bar 13, the quantum dot package 12 and the dot light source 11 are disposed on one side surface of the light guiding plate 15 having a front surface and a rear surface in a rectangular shape, and four side surfaces between the front surface and the rear surface. The light guiding bar 13 has a both-sided wedge shape, a center width of which is widest and the width of which is decreased as being closer to both ends, and the quantum dot package 12 and the dot light source 11 are disposed at the center of the light guiding bar 13. In an exemplary embodiment, as shown in FIG. 2, the light guiding bar 13, the quantum dot package 12 and the dot light source 11 may be disposed on a long side surface of the light guiding plate 15, but not being limited thereto. In an alternative exemplary embodiment, the light guiding bar 13, the quantum dot package 12 and the dot light source 11 may be disposed on a short side surface of the light guiding plate 15.

In an alternative exemplary embodiment of a light source unit, as shown in FIG. 3, a light guiding bar 14 having a wedge shape is disposed on the short side surface of the light guiding plate 15, and the quantum dot package 12 and the dot light source 11 are disposed on a surface of the light guiding bar 14 corresponding to a wedge head of the wedge shape of the light guiding bar 14. In such an embodiment, the light guiding bar 14, the quantum dot package 12 and the dot light source 11 may be disposed on the short side surface of the light guiding plate 15, as shown in FIG. 3, but not being limited thereto. In another alternative exemplary embodiment, the light guiding bar 14, the quantum dot package 12 and the dot light source 11 may be disposed on the long side surface of the light guiding plate 15.

In such embodiments described above, the light source unit may have excellent light uniformity and include reduced amount of a quantum dot material compared with an embodiment where the quantum dot packages are widely disposed on the light emission surface of the light guiding plate, thereby reducing manufacturing cost.

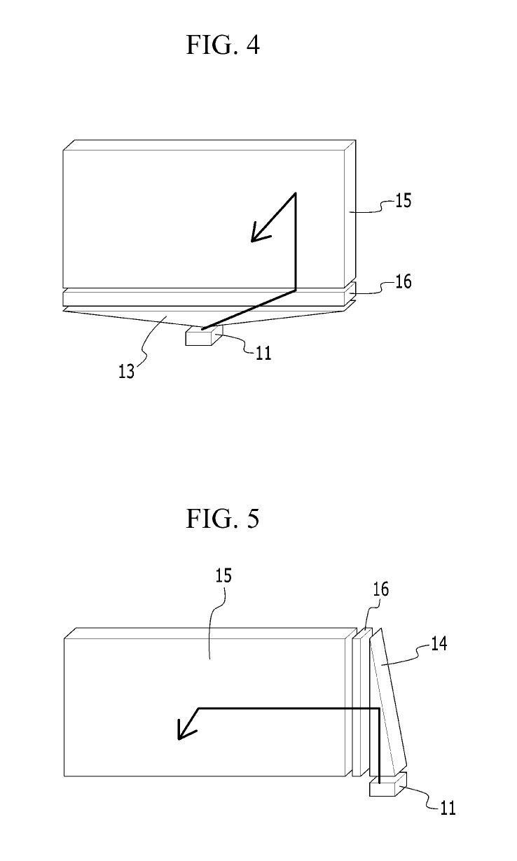

In another alternative exemplary embodiment of a light source unit, as shown in FIG. 4, a bar shaped quantum dot package 16, the both-sided wedge shaped light guiding bar 13 and the dot light source 11 are sequentially disposed at one side of the long side surfaces of the light guiding plate 15. In such an embodiment, the bar shaped quantum dot package 16, the light guiding bar 13 and the dot light source 11 are disposed on the long side surface of the light guiding plate 15, but not being limited thereto. In another alternative exemplary embodiment, the bar shaped quantum dot package 16, the light guiding bar 13 and the dot light source 11 may be disposed on the short side surface of the light guiding plate 15.

In another alternative exemplary embodiment of a light source unit, as shown in FIG. 5, the bar shaped quantum dot package 16 and the wedge shaped light guiding bar 14 are sequentially disposed on one side of the short side surface of the light guiding plate 15, and the dot light source 11 is disposed on the surface of the wedge shaped light guiding bar 14 corresponding to the wedge head therein.

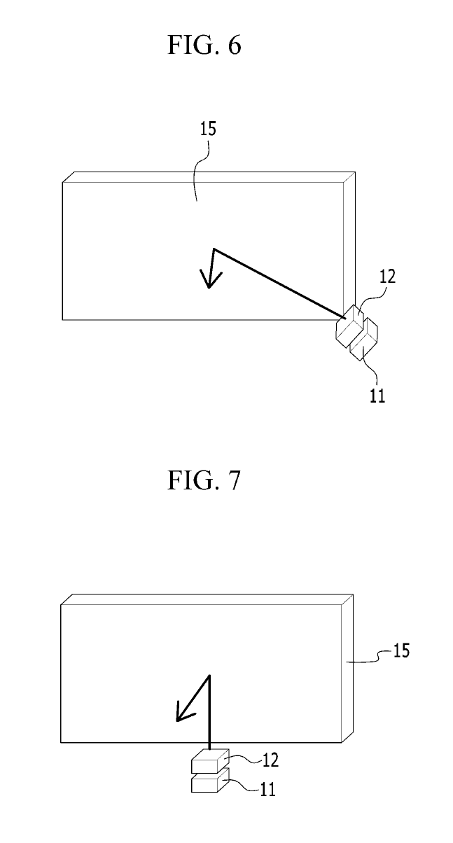

In another alternative exemplary embodiment of a light source unit, as shown in FIG. 6, the quantum dot package 12 and the dot light source 11 are disposed on one of four corners of the light guiding plate 15, where the side surfaces of the light guiding plate 15 are connected to each other. A point of the corner of the light guiding plate 15 where the quantum dot package 12 and the dot light source 11 are disposed may be cut, e.g., chamfered, thereby defining a plane surface, and the quantum dot package 12 and the dot light source 11 may be disposed on the plane surface.

In another alternative exemplary embodiment of a light source unit, as shown in FIG. 7, the quantum dot package 12 and the dot light source 11 are disposed at a center of one of the long side surfaces of the light guiding plate 15, but not being limited thereto. In another alternative exemplary embodiment, the quantum dot package 12 and the dot light source 11 may be disposed at a center of one of the short side surface of the light guiding plate 15.

In exemplary embodiments of the invention, as described above, a light source unit may include a single dot light source. In such an embodiment, the light source unit may be included in a liquid crystal display device having a small size, and the light emitted from the single dot light source may provide sufficient brightness. In an exemplary embodiment, where the size of the display device including the light source unit is substantially large or configured to display an image with high brightness, the light source unit may include a plurality of dot light sources to improve the brightness.

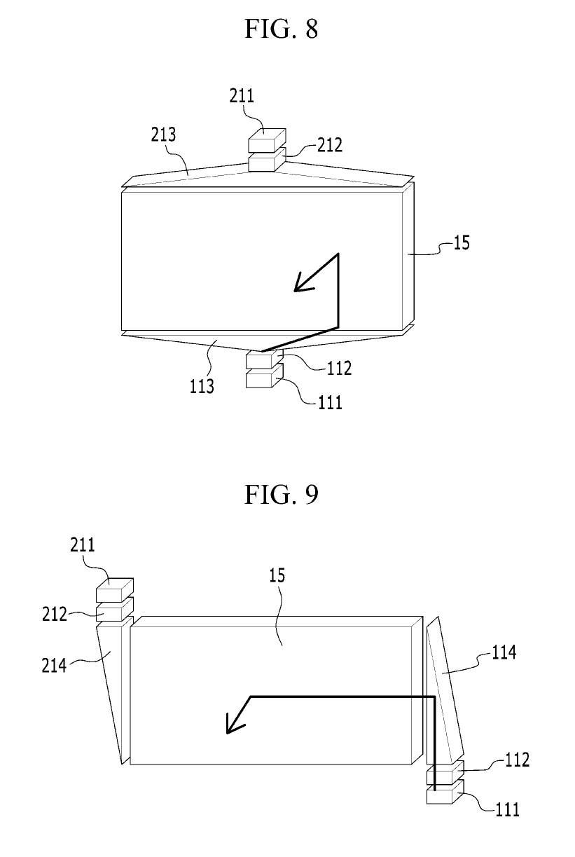

In another alternative exemplary embodiment of a light source unit, as shown in FIG. 8, both-sided wedge shaped light guiding bars (e.g., first and second both-sided wedge shaped light guiding bars 113 and 213), quantum dot packages (e.g., first and second quantum dot packages 112 and 212), and dot light sources (e.g., first and second dot light sources 111 and 211) are symmetrically disposed on two long side surfaces of the light guiding plate 15. In an alternative exemplary embodiment, the both-sided wedge shaped light guiding bars 113 and 213, the quantum dot packages 112 and 212, and the dot light sources 111 and 211 may be disposed on the short side surface instead of the long side surface of the light guiding plate 15.

In another alternative exemplary embodiment of a light source unit, as shown in FIG. 9, wedge shaped light guiding bars (e.g., first and second wedge shaped light guiding bars 114 and 214) may be disposed with dot symmetry (point reflection symmetry) with respect to a center point of the light guiding plate 15, and on the two short side surfaces of the light guiding plate 15, and the quantum dot packages 112 and 212 and the dot light sources 111 and 211 are disposed with dot symmetry (point reflection symmetry) with respect to a center point of the light guiding plate 15, and on the surface corresponding to the wedge head of the wedge shaped light guiding bars 114 and 214, respectively. In such an embodiment, as shown in FIG. 9, the wedge shaped light guiding bars 114 and 214, the quantum dot packages 112 and 212, and the dot light sources 111 and 211 may be disposed on the short side surface of the light guiding plate 15, but not being limited thereto. In such an embodiment, the light guiding bars 114 and 214, the quantum dot packages 112 and 212 and the dot light sources 111 and 211 are disposed to have dot symmetry (point reflection symmetry) with respect to the center point of the light guiding plate 15, but not being limited thereto. In an alternative exemplary embodiment, the light guiding bars 114 and 214, the quantum dot packages 112 and 212 and the dot light sources 111 and 211 may be disposed to have inverse symmetry with respect to an imaginary vertical center line of the light guiding plate 15.

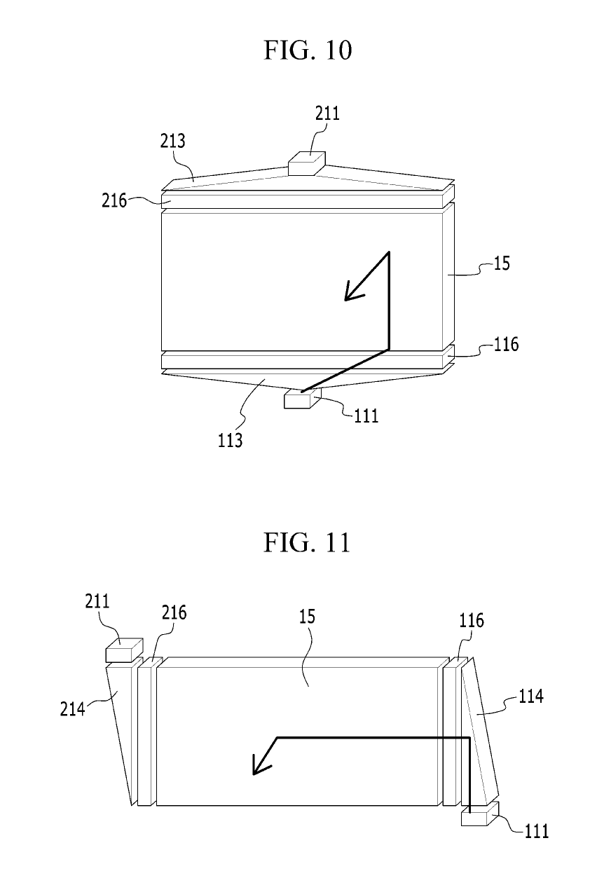

In another alternative exemplary embodiment of a light source unit, as shown in FIG. 10, bar shaped quantum dot packages (e.g., first and second bar shaped quantum dot packages 116 and 216), the both-sided wedge shaped light guiding bars 113 and 213, and the dot light sources 111 and 211 are sequentially disposed on the two long side surfaces of the light guiding plate 15, respectively. The bar shaped quantum dot packages 116 and 216, the both-sided wedge shaped light guiding bars 113 and 213, and the dot light sources 111 and 211 are symmetrically disposed to each other with respect to the light guiding plate 15 (e.g., an imaginary horizontal center line of the light guiding plate 15). In an alternative exemplary embodiment, the bar shaped quantum dot packages 116 and 216, the both-sided wedge shaped light guiding bars 113 and 213, and the dot light sources 111 and 211 may be disposed on the short side surfaces of the light guiding plate 15, respectively, and may be symmetrically disposed to each other with respect to the imaginary vertical center line of the light guiding plate 15.

In another alternative exemplary embodiment of a light source unit, as shown in FIG. 11, the bar shaped quantum dot packages 116 and 216, and the wedge shaped light guiding bars 114 and 214 are sequentially disposed on the short side surfaces of the light guiding plate 15, and the dot light sources 111 and 211 are respectively disposed on the surfaces of the wedge shaped light guiding bars 114 and 214 corresponding to the wedge head of the light guiding bars 114 and 214. The bar shaped quantum dot packages 116 and 216, the wedge shaped light guiding bars 114 and 214, and the dot light sources 111 and 211 are disposed symmetrically to each other with respect to the light guiding plate 15. In an alternative exemplary embodiment, the bar shaped quantum dot packages 116 and 216, the wedge shaped light guiding bars 114 and 214, and the dot light sources 111 and 211 may be disposed on the long side surfaces of the light guiding plate 15, respectively.

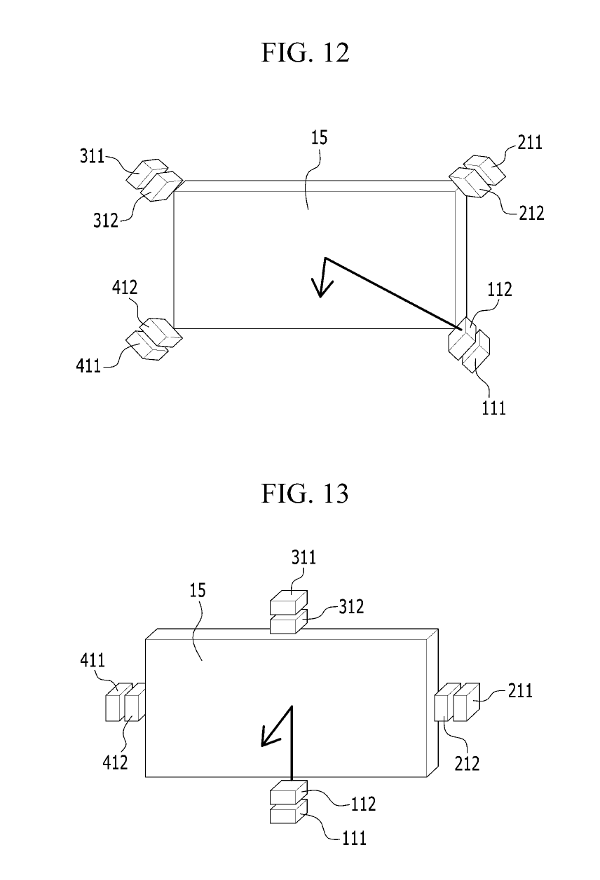

In another alternative exemplary embodiment of a light source unit, as shown in FIG. 12, quantum dot packages (e.g., first to fourth quantum dot packages 112, 212, 312, 412) and dot light sources (e.g., first to fourth dot light sources 111, 211, 311, 411) are respectively disposed at four corners of the side surface of the light guiding plate 15. The points of four corners of the light guiding plate 15 where the quantum dot packages 112, 212, 312, 412 and the dot light sources 111, 211, 311, 411 are disposed may be cut or chamfered, thereby defining plane surfaces, and the quantum dot packages 112, 212, 312, 412 and the dot light sources 111, 211, 311, 411 may be disposed on the plane surfaces, respectively.

In another alternative exemplary embodiment of a light source unit, as shown in FIG. 13, the quantum dot packages 112, 212, 312, 412 and the dot light sources 111, 211, 311, 411 are respectively disposed on centers of four side surfaces of the light guiding plate 15. In an alternative exemplary embodiment, the quantum dot packages 112, 212, 312, 412 and the dot light sources 111, 211, 311, 411 may be disposed only on two or three side surfaces among four side surfaces of the light guiding plate 15.

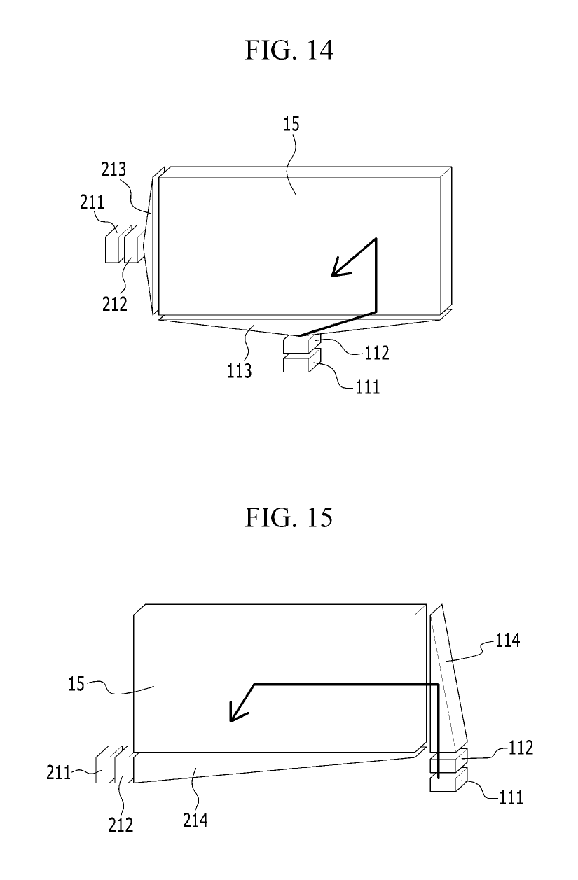

In another alternative exemplary embodiment of a light source unit, as shown in FIG. 14, the both-sided wedge shaped light guiding bars 113 and 213, the quantum dot packages 112 and 212, and the dot light sources 111 and 211 are respectively disposed on one of two long side surfaces of the light guiding plate 15 and one of two short side surfaces.

In another alternative exemplary embodiment of a light source unit, as shown in FIG. 15, the wedge shaped light guiding bars 114 and 214 are respectively disposed on one of two short side surfaces of the light guiding plate 15 and one of two long side surfaces, and the quantum dot packages 112 and 212, and the dot light sources 111 and 211 are respectively disposed on the surface corresponding to the wedge head in the light guiding bars 114 and 214. In an alternative exemplary embodiment, the sharp ends of two light guiding bars 114 and 214 may be disposed to face toward a same corner of the light guiding plate 15.

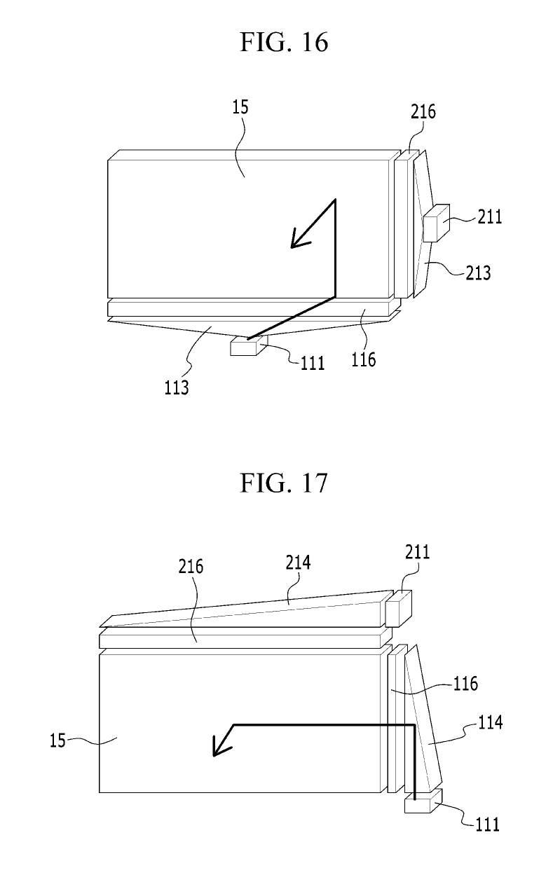

In another alternative exemplary embodiment of a light source unit, as shown in FIG. 16, the bar shaped quantum dot packages 116 and 216, the both-sided wedge shaped light guiding bars 113 and 213, and the dot light sources 111 and 211 are respectively and sequentially disposed on one of two long side surfaces of the light guiding plate 15 and one of two short side surfaces.

In another alternative exemplary embodiment of a light source unit, as shown in FIG. 17, the bar shaped quantum dot packages 116 and 216, and the wedge shape light guiding bars 114 and 214 are sequentially and respectively disposed on one of two long side surfaces of the light guiding plate 15 and one of two short side surfaces, and the dot light sources 111 and 211 are disposed on the surface corresponding to the wedge head in the light guiding bars 114 and 214. In alternative exemplary embodiment, the sharp ends of two light guiding bars 114 and 214 may be disposed to face toward a same corner of the light guiding plate 15.

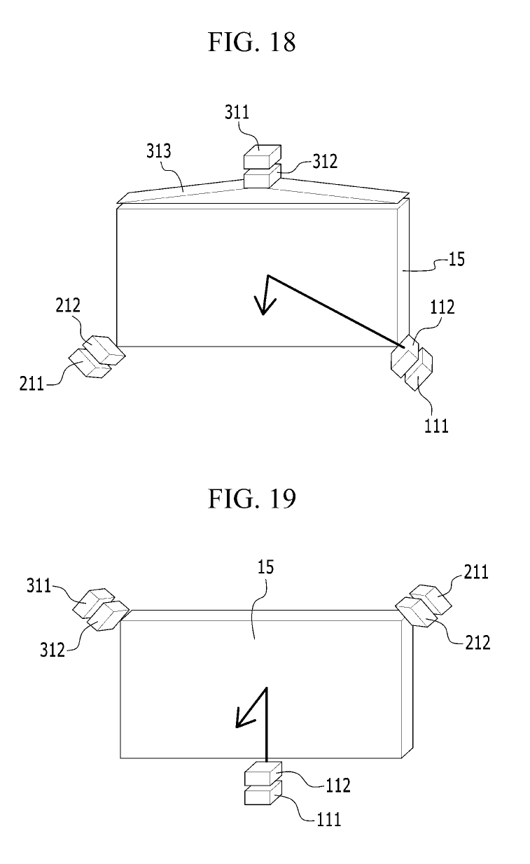

In another alternative exemplary embodiment of a light source unit, as shown in FIG. 18, the first and second quantum dot packages 112 and 212, and the first and second dot light sources 111 and 211 are disposed on two of four corners of the side surfaces (e.g., opposing side edges of a long side surface) of the light guiding plate 15, and a both-sided wedge shaped light guiding bar 313, the third quantum dot package 312, and the third dot light source 311 are sequentially disposed on a side surface opposite to the corner at which the first and second quantum dot packages 112 and 212, and the first and second dot light sources 111 and 211 are disposed. The points of two corners of the light guiding plate 15 where the first and second quantum dot packages 112 and 212 and the first and second dot light sources 111 and 211 are disposed may be cut or chamfered, thereby defining plane surfaces, and the first and second quantum dot packages 112 and 212 and the first and second dot light source 111 and 211 may be disposed on the plane surfaces, respectively. The first and second quantum dot packages 112 and 212 and the first and second dot light sources 111 and 211 may be disposed on opposing side edges of a first short side surface of the light guiding plate 15, and the both-sided wedge shaped light guiding bar 313, the third quantum dot package 312, and the third dot light source 311 may be disposed on a second short side surface opposite to the first short side surface of the light guiding plate 15.

In another alternative exemplary embodiment of a light source unit, as shown in FIG. 19, the second and third quantum dot packages 212 and 312, and the second and third dot light sources 211 and 311 are disposed on two of four corners of the side surfaces of the light guiding plate 15, and the first quantum dot package 112 and the first dot light source 111 are disposed on a center of a side surface opposite to the corners where the second and third quantum dot packages 212 and 312 and the second and third dot light sources 211 and 311 are disposed. The points of two corners of the light guiding plate 15 where the second and third quantum dot packages 2 and 312 and the second and third dot light sources 211 and 311 are disposed may be cut or chamfered, thereby defining the plane surface, and the second and third quantum dot packages 212 and 312 and the second and third dot light sources 211 and 311 may be disposed on the plane surfaces, respectively. In an alternative exemplary embodiment, the second and third quantum dot packages 212 and 312 and the second and third dot light sources 211 and 311 may be disposed at both ends of a short side surface of the light guiding plate 15, and the first quantum dot package 112 and the first dot light source 111 may be disposed at a center of a short side surface of the light guiding plate 15 opposite to the short side surface, both ends of which the quantum dot packages 312 and 212 and the dot light sources 311 and 211 are disposed on.

Such embodiments of the light source units described herein may be used as a rear light source of a display device such as the liquid crystal display device, or a light emitting light source.

While above disclosure is directed to some exemplary embodiments of the invention, it is to be understood that the invention is not limited to the disclosed embodiments, but, on the contrary, is intended to cover various modifications and equivalent arrangements included within the spirit and scope of the appended claims.

What is claimed is:

1. A light source unit comprising:
a light guiding plate having a front surface and a rear surface facing each other and a side surface between the front surface and the rear surface;
a light guiding bar disposed on the side surface of the light guiding plate;
a quantum dot package disposed on a surface of the light guiding bar; and
a dot light source which provides light to the quantum dot package.

2. The light source unit of claim 1, wherein
the light guiding bar has a wedge shape, and
the quantum dot package and the dot light source are disposed on a surface corresponding to a wedge head of the light guiding bar.

3. The light source unit of claim 2, wherein
the light guiding bar comprises first and second light guiding bars disposed in symmetry with respect to the light guiding plate,
the quantum dot package comprises first and second quantum dot packages disposed on surfaces corresponding to wedge heads of the first and second light guiding bars, respectively, and
the dot light source comprises first and second dot light sources disposed on the surfaces corresponding to the wedge heads in the first and second light guiding bars, respectively.

4. The light source unit of claim 2, wherein
each of the front surface and the rear surface of the light guiding plate is in a rectangular shape,
the side surface of the light guiding plate comprises:
a pair of long side surfaces facing each other; and
a pair of short side surfaces facing each other,
the light guiding bar comprises:
a first light guiding bar disposed on one of the short side surfaces of the light guiding plate; and
a second light guiding bar disposed on one of the long side surfaces of the light guiding plate,
the quantum dot package comprises:
a first quantum dot package disposed on a surface corresponding to a wedge head of the first light guiding bar; and
a second quantum dot package disposed on a surface corresponding to a wedge head of the second light guiding bar, and
the dot light source comprises:
a first dot light source disposed on the first quantum dot package; and
a second dot light source disposed on the second quantum dot package.

5. The light source unit of claim 1, wherein
the light guiding bar has a both-sided wedge shape, and
the quantum dot package and the dot light source are disposed on a center of the light guiding bar.

6. The light source unit of claim 5, wherein
the light guiding bar comprises first and second light guiding bars disposed in symmetry to each other with respect to the light guiding plate,
the quantum dot package comprises first and second quantum dot packages disposed on centers of the first and second light guiding bars, respectively, and
the dot light source comprises first and second dot light sources disposed on the first and second quantum dot packages, respectively.

7. The light source unit of claim 5, wherein
each of the front surface and the rear surface of the light guiding plate has a rectangular shape,
the side surface of the light guiding plate comprises:
a pair of long side surfaces facing each other; and
a pair of short side surfaces facing each other,
the light guiding bar comprises:
a first light guiding bar disposed on one of the short side surfaces of the light guiding plate; and
a second light guiding bar disposed on one of the long side surfaces of the light guiding plate,
the quantum dot package comprises:
a first quantum dot package disposed on a center of the first light guiding bar; and
a second quantum dot package disposed on a center of the second light guiding bar, and
the dot light source comprises:
a first dot light source disposed on the first quantum dot package; and
a second dot light source disposed on the second quantum dot package.

8. The light source unit of claim 5, wherein
each of the front surface and the rear surface of the light guiding plate is in a rectangular shape,
the side surface of the light guiding plate comprises:
a pair of long side surfaces facing each other; and
a pair of short side surfaces facing each other, and
the light guiding bar is disposed on one of four side surfaces of the light guiding plate,
the quantum dot package comprises:
a first quantum dot package disposed on the one of the four side surfaces of the light guiding plate; and
second and third quantum dot packages respectively disposed on two corners opposite to the one of the four side surfaces, and the dot light source comprises:
a first dot light source disposed on the one of the four side surfaces of the light guiding plate; and
second and third dot light sources respectively disposed on the two corners opposite to the one of the four side surfaces.

9. A light source unit comprising:
a light guiding plate having a front surface and a rear surface facing each other, and a side surface between the front surface and the rear surface;
a light guiding bar disposed on the side surface of the light guiding plate;
a bar shaped quantum dot package disposed between the light guiding bar and the side surface of the light guiding plate; and
a dot light source which provides light to the light guiding bar.

10. The light source unit of claim 9, wherein
the light guiding bar has a wedge shape, and
the dot light source is disposed on a surface corresponding to a wedge head of the light guiding bar.

11. The light source unit of claim 10, wherein
the bar shaped quantum dot package comprises first and second bar shaped quantum dot packages disposed in symmetry to each other with respect to the light guiding plate,
the light guiding bar comprises first and second light guiding bars disposed on the first and second bar shaped quantum dot packages, respectively, and
the dot light source comprises first and second dot light sources disposed on surfaces corresponding to wedge heads of the first and second light guiding bars, respectively.

12. The light source unit of claim 10, wherein
each of the front surface and the rear surface of the light guiding plate is in a rectangular shape,
the side surface of the light guiding plate comprises:
a pair of long side surfaces facing each other; and
a pair of short side surfaces facing each other,
the light guiding bar comprises:
a first light guiding bar disposed on one of the short side surfaces of the light guiding plate; and
a second light guiding bar disposed on one of the long side surfaces of the light guiding plate,
the bar shaped quantum dot package comprises:
a first bar shaped quantum dot package disposed between the light guiding plate and the first light guiding bar; and
a second bar shaped quantum dot package disposed between the light guiding plate and the second light guiding bar, and
the dot light source comprises:
a first dot light source disposed on a surface corresponding to a wedge head of the first light guiding bar; and
a second dot light source disposed on a surface corresponding to a wedge head of the second light guiding bar.

13. The light source unit of claim 9, wherein
the light guiding bar has a both-sided wedge shape, and
the dot light source is disposed on a center of the light guiding bar.

14. The light source unit of claim 13, wherein
the bar shaped quantum dot package comprises first and second bar shaped quantum dot packages disposed in symmetry to each other with respect to the light guiding plate,
the light guiding bar comprises first and second light guiding bars disposed on the first and second bar shaped quantum dot packages, respectively, and
the dot light source comprises first and second dot light sources disposed on centers of the first and second light guiding bars, respectively.

15. The light source unit of claim 13, wherein
each of the front surface and the rear surface of the light guiding plate is in a rectangular shape,
the side surface of the light guiding plate comprises:
a pair of long side surfaces facing each other; and
a pair of short side surfaces facing each other,
the light guiding bar comprises:
a first light guiding bar disposed on one of the short side surfaces of the light guiding plate; and
a second light guiding bar disposed on one of the long side surfaces of the light guiding plate,
the bar shaped quantum dot package comprises:
a first bar shaped quantum dot package disposed between the light guiding plate and the first light guiding bar; and
a second bar shaped quantum dot package disposed between the light guiding plate and the second light guiding bar, and
the dot light source comprises:
a first dot light source disposed on a center of the first light guiding bar; and
a second dot light source disposed on a center of the second light guiding bar.

16. A light source unit comprising:
a light guiding plate having a front surface and a rear surface facing each other, and a side surface between the front surface and the rear surface;
a quantum dot package disposed on the side surface of the light guiding plate and which directly provides light to the light guiding plate; and
a dot light source which provides light to a quantum dot package.

17. The light source unit of claim 16, wherein
each of the front surface and the rear surface of the light guiding plate is in a rectangular shape,
the side surface of the light guiding plate comprises:
a pair of long side surfaces facing each other; and
a pair of short side surfaces facing each other, and
the quantum dot package and the dot light source are disposed on at least one of four corners of the light guiding plate.

18. The light source unit of claim 17, wherein
the quantum dot package and the dot light source are disposed on each of all of the four corners of the light guiding plate.

19. The light source unit of claim 16, wherein
each of the front surface and the rear surface of the light guiding plate is in a rectangular shape,
the side surface of the light guiding plate comprises:
a pair of long side surfaces facing each other; and
a pair of short side surfaces facing each other, and
the quantum dot package and the dot light source are disposed on at least one of four side surfaces of the light guiding plate.

20. The light source unit of claim 19, wherein
the quantum dot package and the dot light source are disposed on a center of each of the four side surface of the light guiding plate.

21. The light source unit of claim 19, further comprising:
the quantum dot package comprises:
a first quantum dot package disposed on the at least one of the four side surfaces of the light guiding plate; and
a second quantum dot package disposed on at least one of four corners of the light guiding plate, and
the dot light source comprises:
a first dot light source disposed on the at least one of the four side surfaces of the light guiding plate; and
a second dot light source disposed on the at least one of the four corners of the light guiding plate.
